(19) United States
(12) Patent Application Publication
(10) Pub. No.: US 2004/0032051 A1
(43) Pub. Date: Feb. 19, 2004

(54) Method for Producing Profiles

(76) Inventor: Axel Schulte, Holzgerlingen (DE)

Correspondence Address: Mark S Bicks Roylance Abrams berdo & Goodman, 1300 19th Street N W, Suite 600, Washington, DC, 20036, US

(21) Appl. No.: 10/416,585

(22) PCT Filed: Oct. 23, 2001
(86) PCT No.: PCT/EP01/12198

(30) Foreign Application Priority Data
Nov. 24, 2000 (DE) 100 58 889.1

(51) Int. Cl. B29C 47/20

(52) U.S. Cl. 264/209.3

(57) ABSTRACT

The invention relates to a method for the continuous production of piping profiles (10), comprising at least two forming strands (12, 14), each consisting of individual forming components (18) which are allocated in groups and which are held against each other over a predetermined (20) forming distance, while also being provided with a forming material, in such a way that the profile (10) is obtained upon separating the groups of forming components (18). Very high production speeds for producing profile material are possible with the inventive method, allowing a low-cost overall system for the production of fixing systems for automobiles in particular, without the risk of quality defects or similar.

The invention relates to a method for continuous production of piping profile sections.

A process disclosed in EP 0 563 575 B1 is applied for continuous production of a composite pipe consisting of a smooth inner pipe and an outer pipe bonded to it having a connecting sleeve provided with cross-grooves. The process disclosed is characterized by the following process steps. First an outer piping is extruded, the outer piping being provided with a corrugation with cross-grooves by external application of a partial vacuum. The respective corrugation with cross-grooves is obtained by way of jaw-like shaping components which carry out shaping continuously in succession along two shaping trains. An inner hose is then extruded into the outer hose and the inner hose is pressed against the wave troughs of the outer hose and is there suitably bonded to the outer hose. The outer hose itself is then expanded to form a more or less smooth-walled approximately cylindrical connecting sleeve by application of the partial vacuum from the exterior. Devices for continuous production of such corrugated composite tubes are known in a plurality of embodiments and the relevant shaping technology is known in the professional world as “corrugator technology”.

DE 198 08 995 C1 discloses a fastening system for a vehicle seat having at least one upholstery component of a foamed material which is enclosed in at least one upholstery cover component which is connected to at least one solid piping profile serving as interlocking means, said piping profile having on its outer circumference interlocking elements in the form of longitudinal ribs. There is present in the upholstery component a longitudinal channel adapted to the respective shaping strip, the channel having longitudinal recesses serving the purpose of engagement with the interlocking elements. The disclosed fastening system in question is applied for fastening as defined of the upholstery cover component on the upholstery component by way of the interlocking elements of the section, which are engaged directly with the recesses. Adhesive forces which reinforce the dependable connection may arise between the fine-pored foam material and the profile section in the disclosed solution.

The conventional solid piping profile, also termed “sealing strip profile,” is preferably a mono extrudate and consists of a soft plastic such as an elastomer material. Particular preference is given to use of olefins and PVC. The materials may also be disposable and recyclable. A dependable manufacturing process is, of course, guaranteed in production of the sealing strip profile as a mono extrudate by a conventional extrusion device; however, the ejection rates and accordingly the production rates for the profile section are very low, so that the conventional production process for the profile is costly.

On the basis of this state of the art the invention has the object of developing a process of continuous production of solid profiles, a process by which high production rates may be reached and which makes it possible to generate piping profiles of virtually any geometric configurations desired in a cost-effective manner. This object is attained by means of a process having the features specified in claim 1 in its entirety.

In the process claimed for the invention for continuous production of piping profiles two shaping lines are provided each of which consists of individual shaping components which, associated with each other in groups and provided with a shaping material over a predetermined shaping section, are held against each other so that the piping profile is obtained after separation of the groups of shaping components.

Like the corrugator process for production of drain pipes or the like, a shaping material, preferably one in the form of a thermoplastic, is inserted between the shaping lines, the individual jaw-like shaping components effect the shaping process for the profile over a predetermined shaping segment and, as soon as the groups of shaping components have been separated from each other, the finished profile may be removed continuously at the end of the shaping segment for later use. The length selected for the shaping segment is such that reliable shaping can be obtained and a certain remainder of the stretch is available which serves the purpose of cooling of the profile to its shape as defined.

Very high production rates can be reached for the profile material of the process claimed for the invention, so that a cost-effective overall system for production of fastening systems in motor vehicles may be obtained without fear of quality deficiencies or the like.

In an especially preferred embodiment of the process claimed for the invention two associated shaping lines are provided and the individual shaping components of shaping jaws are formed in such a way that each shaping jaw has at least in part a profile recess and the piping profile is formed with all profile recesses collectively. In this way, among other things a dependable mold removal process at the end of the shaping segment is ensured, since the finished profile is forcibly disengaged from the groups of shaping jaws.

In another preferred embodiment of the process claimed for the invention an intake gap by way of which a supplied fitting strip component is joined to the profile is delimited between the shaping jaws of the shaping components which are held against each other to form the shaping segment. The fitting strip in question forms a kind of fabric sew-on vane by which the profile may later be joined to the cover material for a motor vehicle seat or the like by means of an adhesive or connecting stitch (see, for example, DE 199 52 416 C1). The fitting strip preferably consists of a plastic or textile fabric which is as tear-resistant as possible. The fitting strip may be introduced into the center of the profile or be connected by a part of its external circumference so as to effect shaping.

In another preferred embodiment of the process claimed for the invention each profile recess is provided on the circumference side with at least one ribbed lengthwise channel which together with the profile recess forms a hollow recess. When the profile is subsequently produced, ribbed interlocking elements are formed on the outside of the profile by way of the respective ribbed lengthwise channels; this makes improved engagement of profile possible later when the fastening system is introduced into the foam material.

The shaping material preferably is made up of a thermoplastic and is inserted between the adjacent shaping lines with their shaping components by way of an extruder and feed device at the beginning of the shaping segment. Since the respective shaping lines make continuous production of the profile possible, it is advantageous if the initial material, preferably in the form of a thermoplastic material, can be fed continuously by way of the extruder and feed device.

In addition, the shaping components of each shaping line are moved in a closed cycle and are driven by a central drive so that the shaping components separately come in contact with each other and transmit the drive impetus imparted to the shaping component following in the cycle. Dependable propulsion of the shaping lines is thus guaranteed with low drive forces and accordingly with low drive energy forces. Since the shaping components come into contact only separately with each other, worn shaping components can be immediately and very quickly replaced. The possibility also exists of arranging shaping components of the most widely varying kinds, that is, ones with cavities of the most widely varying shapes, in any predetermined sequence desired, in order to obtain profiles which themselves are provided with the most widely varying cross-sections. The direction selected for penetration of the plastic material between the shaping lines is parallel to the direction of circular movement, but it is also possible to introduce the plastic matter transversely to this direction of circular movement between the free gaps of the groups of shaping components which may be associated with each other. In any event, however, the configurations of features as described in the foregoing permit very rapid progress of the operation for production of the profile to be made.

In another preferred embodiment of the process claimed for the invention the shaping components are connected by their cavities for profile generation to a device generating a pressure medium and/or generating a vacuum, a heating and/or cooling device being provided in addition or as an alternative for the shaping components. If use is made of a device generating a vacuum, this improves the pattern of inflow of the plastic material into the cavities of the shaping components. If a pressure medium is introduced into the cavities, this may improve the ausforming for the profile with its interlocking elements from the shaping components. The shaping process may be additionally controlled by way of a heating or cooling device, it being possible to keep the plastic material plasticizable for a longer period during heating of this material or to reduce the period by cooling the material and the finished profile may be quickly removed from the device with the shaping lines.

If the shaping components are modular in structure, the type of profile generating profile recesses or cavities may be modified by changing the shaping inserts so that basically a plurality of the widest possible variety of profiles with the most widely varying geometries may be produced in the shortest possible time with only one corrugator device.

The process claimed for the invention is described in what follows with reference to the drawing, in which, in diagrammatic form not drawn to scale

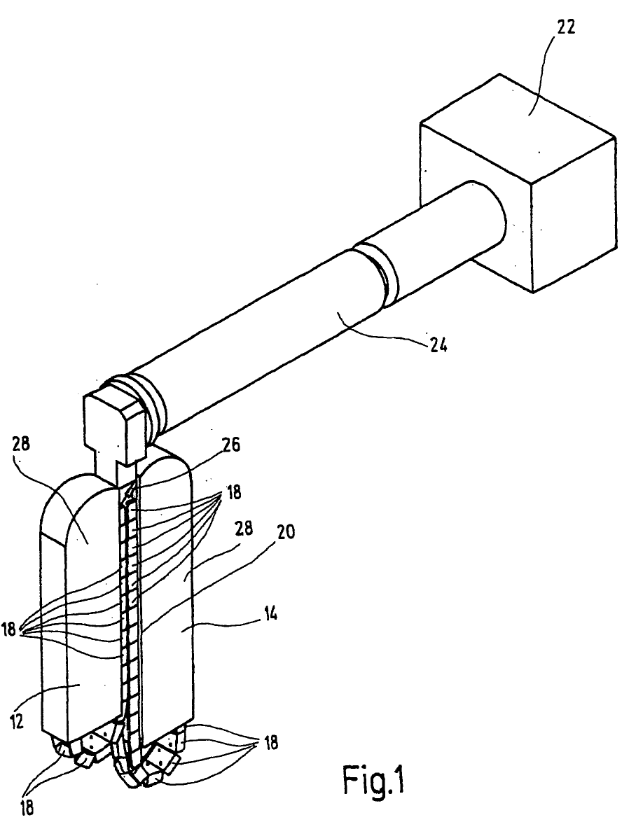

FIG. 1 presents a perspective view of the production device;

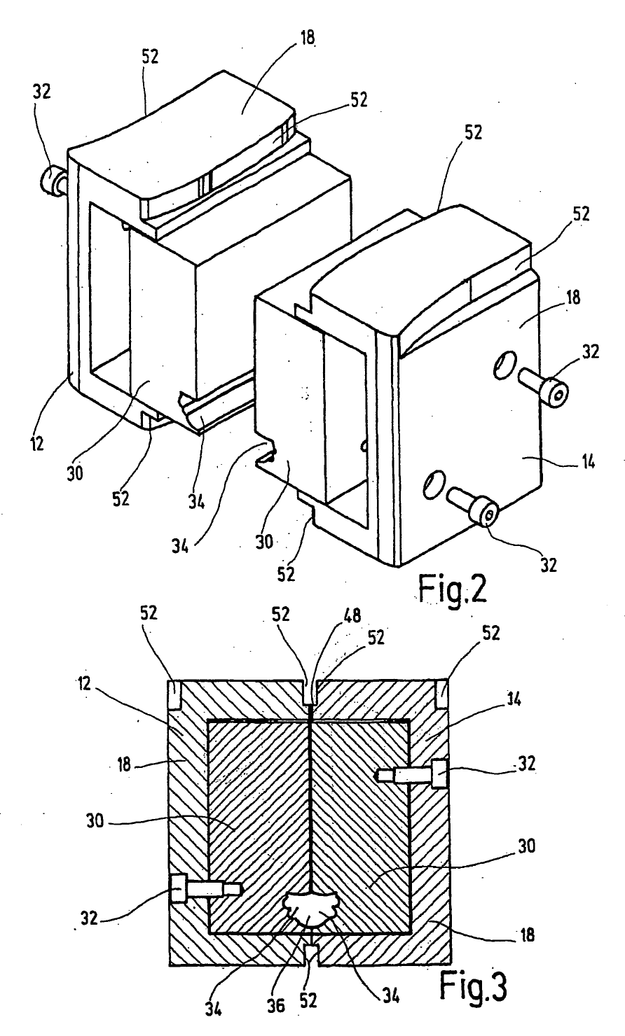

FIG. 2 a perspective view of two shaping components of the two shaping lines forming one group as illustrated in FIG. 1;

FIG. 3 a section through the partial component shaping system shown in FIG. 2, when the shaping components are positioned one atop the other to form one overall mold;

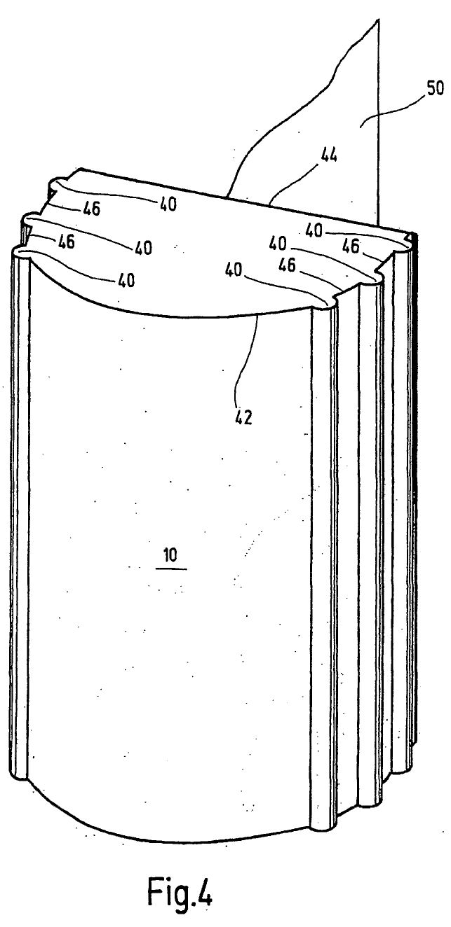

FIG. 4 a profile produced with the device as illustrated in FIGS. 1 to 3.

The device illustrated in FIG. 1 is used to carry out a process of continuous production of profiles 10, especially ones in the form of piping profiles as illustrated by a detailed drawing in FIG. 4. The device has two shaping lines 12, 14, the right shaping line 14 as viewed in the line of sight to FIG. 1 extending further than the left shaping line 12. The assembly in question makes it possible to provide below the shaping line 12 a handling mechanism (not shown) which is capable of removing the profile 10 from the right shaping line 14 by a form of constrained guidance. However, in one embodiment of the device (not shown) it is possible for the two shaping lines to be of more or less equal length and for the profile 10 to be removed from the device through the outlet gap, which becomes wider at the lower end.

The two shaping lines 12, 14 consist each essentially of individual shaping components 18 which are work-connected in groups over a predetermined shaping segment 20. In the embodiment shown in FIG. 1 the shaping segment 20 is made up essentially of twelve groups of shaping components 18 which, arranged in consecutive rows, make contact with each other along their edges (see FIG. 3). The shaping segment 20 in question may be appreciably lengthened or shortened relative to the embodiment illustrated in FIG. 1, as a function of the particular application involved.

The shaping material proper for production of the profile 10 may consist by preference of a thermoplastic, such as a polyamide, but plastics such as elastomer materials, olefins, PVC, and the like are also conceivable. The shaping material is advanced by way of an extruder mechanism 22 and a feed mechanism 24 which is provided on its lower side facing the two shaping lines 12 and 14 with a feed nozzle 26 in order to deliver the plastic material continuously in measured batches for the process of shaping the profile 10.

As is also to be seen in FIG. 1, the individual shaping components 18 of each shaping line 12, 14 extend in a closed cycle, this closed cycle being only partly visible with respect to the two coverings 28. Each shaping line 12, 14 is driven, either individually or collectively, by a central drive (not shown), in such a way that the shaping components 18 separately strike the shaping component 18 following in the direction of circulation with the impetus applied to them. Since the drive technology in question is known in corrugator technology for production of drain pipes or the like and the production device illustrated in FIG. 1 is similar in structure from the viewpoint of basic concept, it will be discussed here only to the extent that such discussion is essential for explaining the production process claimed for the invention.

The direction of propulsion is clockwise for the shaping line 12 and counterclockwise for the shaping line 14 in question. Consequently, as viewed in the line of sight to FIG. 1 the two shaping components 18 forming a group nearest the feed nozzle 26 are filled by the latter with the molding material and then uniformly advanced from the top downward, a new pair of shaping components 18 being continuously closed by the shaping lines 12, 14 in the area of the feed nozzle 26, from which the plastic material continuously flows.

The two shaping components 18 are then separated from each other at the bottom of the device and free the profile 10 for removal. Consequently, the direction selected for penetration of the plastic material between the shaping lines 12, 14 is such that this direction extends parallel to the direction of rotation of the segments. In one embodiment (not shown) it also would be entirely possible, however, to mount the feed nozzle 26 transversely to the direction of propulsion and inject the plastic material into the shaping components 18 from the side. In addition, the device as shown in FIG. 1 may be oriented horizontally, opposite the vertical positioning illustrated in the figure, so that the molding section would then stand perpendicularly to the plane of the drawing.

The device illustrated in FIG. 1 may, by a conventional method not shown, have a device producing a pressure medium and/or producing a vacuum and in addition or as an alternative be provided with a heating and/or cooling device (not shown) for the shaping components 18. Molding of the plastic material in the cavities is facilitated by generation of negative pressure in the shaping components 18 if the shaping components 18 can be connected by their cavities to a device producing a vacuum. If a device generating a pressure medium, especially a device producing compressed air, is used, the ejection process may be facilitated by application of the pressure medium at the end of the shaping. If a heating device is used, the plastic material may be kept longer in the plastic state, a condition which also facilitates flow of the plastic material into the associated cavities. A cooling device results in more rapid setting of the plasticized plastic material in the shaping components 18 and consequently in shortening of the shaping segment 20 which otherwise, without a cooling device, must be dimensioned to be greater from the viewpoint of structural length.

FIG. 2 illustrates two associated shaping components 18 in the form of shaping jaws 30. The shaping jaws 30 are in the form of square shaping stones and surrounded by the clamp-like shaping components 18 on their longitudinal edges. Conventional screws 32 are used to secure the shaping jaws 30 in the shaping components 18. When the screws have been tightened the shaping jaws 30 assume an installed position inside the shaping components 18, as is illustrated in a sectional view in FIG. 3, in which position the facing end surfaces of the two shaping components 18 as illustrated in FIG. 1 rest against each other.

As viewed in the line of sight to FIGS. 2 and 3, a profile recess 34 is provided on both sides on the lower half of the shaping jaws 30, the two profile recesses 34 together forming in cross-section a hollow channel 36 (see FIG. 3) whose cross-section corresponds to the cross-section of the profile strip 10 shown in FIG. 4. Each profile recess 34, in the form of a half-profile, is provided on the side of the circumference with three ribbed longitudinal channels 38 which later form the strip-like interlocking elements 40 on the outer circumference 42 of the profile 10.

As is also to be seen in FIG. 4, the interlocking elements 40 referred to are an integral part of the segment 12 and, as profile-like extensions into groove-like recesses in an upholstery component (not shown) may be engaged over their entire longitudinal orientation in order thus to form a fastening system between upholstery components of a vehicle seat (not shown) and an upholstery cover material or the like. The outer circumference 42 as viewed in the line of sight to FIG. 4 facing the observer is convex in shape and thus provided with a rounding; in contrast, the rear wall 44 of the outer circumference 42 is in the form of a plane. Between the ribbed interlocking elements 40 are intermediate sections 46 of the outer circumference 32, which also are convex.

As FIG. 3 also shows, the two shaping jaws 30 facing each other of the two shaping components 18 together define an inlet gap 48 by way of which a delivered extension component 50 (see FIG. 4) is connected to the profile 10. Use is made for delivery of the extension component 50 in the form of a fabric sew-on vane (see FIG. 4) of an insertion device (not shown), which, as is indicated in FIG. 1, ensures continuous delivery of the textile material in the upper area of the shaping segment 20. Since the inlet gap 48 enters the center of the hollow channel 36, the extension component 50 is applied more or less in the center of the wall 44. An upholstery cover material may be fastened to the free end of the extension component 50, for example, by an adhesive connection or a seam. Terminal systems such as this are disclosed, for example, in DE 199 52 416 C1; hence they need not be discussed in detail here. In any event, the profile 10 with extension component 50 on the lower end and outlet gap of the device as shown in FIG. 1 emerges from the latter and is immediately available for use as a fastening system.

Guide surfaces 52 molded onto the shaping components 18 serve as a guide device by means of which the individual shaping components 18 may be guided along the circular paths of the shaping device as defined. In addition to the rotary mounting illustration the possibility also exists, in an embodiment of the device not illustrated, of moving a group at a time of the shaping components 18 by way of constrained guidance of the feed mechanism directly toward or away from each other axially. Higher moving forces may then be applied to the shaping components 18 by way of the constrained guidance in question and the respective profile 10 may be ejected more or less perpendicularly to the plane of movement of the shaping jaws 30. In the embodiment illustrated in FIG. 1 the shaping jaws 30 are spread apart and guided away in the direction of circular movement so that a continuously increasing removal gap is formed, this resulting in low removal forces and guaranteeing a gentle ejection process, so that the device may also be operated at high band and circulation speeds and a surprisingly faster production process is achieved for the profile 10.

In place of the shaping jaws 30 illustrated in FIGS. 2 and 3, other shaping jaws in the form of interchangeable shaping inserts (not shown) provided with different profile cross-sections may be inserted into the shaping components 18. Consequently, the device illustrated in FIG. 1 may be used to produce a plurality of the widest variety of profiles. It is also possible optionally to employ shaping jaws 30 with different profile cross-sections over the shaping segment 20 in order to obtain a composite profile, a profile line then being outfitted with different cross-sectional shapes, for example, by alternating sections of the profile 10 with interlocking elements 40 with ones (not shown) which are not outfitted with interlocking elements.

In addition, it is possible to provide the plastic material employed with a propellant, such as one in the form of a granulate containing CO₂ which then releases a propellant in the form of CO₂ inside the plastic material under the influence of the temperature and the shaping process. The plastic material foamed in this manner may then be ejected from the device undamaged; in addition, profiles 10 which are very easy to construct but are still strong are obtained. The production process claimed for the invention may be applied to achieve very high production speeds for profiles 10, something by no means to be achieved with conventional extruder equipment. Although the shaping components 18 mounted adjacent to each other are separate, they are held against each other so as to effect sealing; this ensures that plastic material waiting for shaping cannot unintentionally leave the shaping device.

1. A method for continuous producing piping profiles (10) having at least two shaping lines (12, 14) each consisting of individual shaping components (18) which are grouped together and are held together over a predetermined shaping segment (20) and are provided with shaping material in such a way that the profile (10) is obtained after separation of the groups of shaping components (18).

2. The process as claimed in claim 1, wherein two shaping lines (12, 14) associated with each other are provided and the individual shaping components (18) are formed from shaping jaws (30) in such a way that each shaping jaw (30) is so formed that each shaping jaw (30) has at least in part a profile recess (34) and wherein the piping profile (10) is formed by all profile recesses (34) collectively.

3. The process as claimed in claim 2, wherein an inlet gap (48) by way of which a delivered extension component (50) is connected to the profile (10) is defined between the shaping jaws (30) of the shaping components (18) which are held against each other to form the shaping segment (20).

4. The process as claimed in claim 2 or 3, wherein each profile recess (34) is provided on its circumference with at least one ribbed longitudinal channel (38) which forms a hollow channel (36) with the profile recess (34).

5. The process as claimed in one of claims 1 to 4, wherein the shaping material is preferably in the form of a thermoplastic material and is introduced by way of an extruder (22) and feed mechanism (24) between the adjacent shaping lines (12, 14) with their shaping components (18).

6. The process as claimed in claim 5, wherein the shaping components (18) of each shaping line (12, 14) are guided over a closed circular path and are driven by a central drive so that the shaping components (18) strike each other separately to transfer the drive impetus to the shaping component (18) following in the direction of circulation.

7. The process as claimed in claim 6, wherein the direction selected for penetration of the plastic material between the shaping lines (12, 14) extends parallel to such segments or transversely to them.

8. The process as claimed in one of claims 1 to 7, wherein the shaping components (18) are connected by their cavities for producing the profiles (10) to a device generating a pressure medium and/or to a device generating a vacuum and wherein a heating and/or cooling device are/is provided in addition to or as an alternative to the shaping components (18).

9. The process as claimed in one of claims 1 to 8, wherein the shaping components (18) are modular in structure and wherein the type of profiles (10) producing cavities is changed by replacement of shaping inserts.
